(19) United States
(12) Patent Application Publication
(10) Pub. No.: US 2002/0187815 A1
(43) Pub. Date: Dec. 12, 2002

(54) Contact lookup by partial string entry in a communication device

(76) Inventors: Douglas Deeds, Fort Worth, TX (US); Robert C. Rolnik, Southlake, TX (US)

Correspondence Address: ROBERT C. ROLNIK, NOKIA INC., 6000 CONNECTION DRIVE, MD 1-4-755, IRVING, TX, 75039, US

(21) Appl. No.: 09/875,493

(22) Filed: Jun. 6, 2001

(51) Int. Cl. H04M 1/00

(52) U.S. Cl. 455/564; 455/566; 455/550

(57) ABSTRACT

Characters may be entered (103) to a communication device. A data function command (105) may be received. If characters are determined to be partial (107), then a matching routine (106) may be attempted. Detecting at least a match (111) may result in transmitting digits to a network (117). Detecting multiple matches (115) may result in displaying several choices (131). An entered keystroke (135) may select the string of digits or other characters. Any selected string may be transmitted to the network (117).

### BACKGROUND

The invention relates to a mobile station having a database of machine and other contact information and more particularly to selecting a record of contact information in a mobile station based on a partially input record key.

Database a collection of data structured and organized in a disciplined fashion so that access is possible quickly to information of interest. A database is made up of two elements, a record and a field. A record is one complete entry in a database, e.g. Gerry Friesen, 12 West 21 Street, New York, N.Y. 10010. A field would be the street address field, namely 12 West 21 Street. Thus a database may include tables, each comprised of one or more records. A first table may have fields limited to subject matter and originators of inventions. A second table may have data limited to fields concerning inventor names, addresses and nationalities. To avoid redundancy in the first table, the first table may simply have a reference or pointer to a record in the second table, which has detailed information concerning the inventor. Because fields of one table may be linked to records of a second table by way of a pointer, the tables are referred to as a single database.

Two tables may have the same number of fields and the same field names. The two tables may be searched contemporaneously whereby an output list comprising records of one or both tables may be presented. Such a search may, in effect, appear as though the results came from a common database, however, because the tables may have no pointers or other referential links between them, the tables are separate and distinct databases.

A mobile telephone may have multiple tables to store information. Some information can be considered configuration information and may describe the identity of the mobile telephone, permissible frequencies, collections of ringing melodies and more. Other information is generally established in the mobile telephone based on use, and particularly based on the use of telephone numbers for, among other things, calling people. In a Nokia 6160 Mobile Phone, there are at least four possible tables of information established by use of the phone:

Missed calls;

Dialed calls;

Received calls; and

Phone book entries.

Phone book entries may include the following fields:

name, which may be a string of characters, usually limited only by the character set of the phone;

telephonic field, which may be digits 0-9 as well as additional telephonic characters or telephonic instructions; and

caller group, a reference to a particular profile used to distinguish an incoming call according to classification of the user.

Telephonic instructions may be commands to dial international access codes, and engage in brief delays, e.g. between providing a telephone number and a personal identifier, as may be required at some Interactive Voice Response (IVR) supported telephone services. Such instructions may be displayed as characters ‘p’, ‘w’, and ‘+’.

One may regard the phone book entry table as a favored table. The use of network browser software includes a favorites listing of uniform resource locators (URL) which may be populated with data by a user of such a browser. Such a favorites listing is also a species of favored table.

URL completion has been known to operate as follows. The first keystrokes entered in the address field of a browser are compared to a list of URLs (history list) that may previously been visited. The list of visited URLs is read from most recent to oldest. If an URL is found from the history list that has characters at its beginning that match the first keystrokes, the browser suggests that URL by displaying the remaining characters using a special type-font or other emphasis.

In U.S. Pat. No. 5,722,088 “Automatic Prefix systems and methods for mobile radiotelephones”, it is shown: “In response to user entry of an extension, such as four or five digits followed by the “send” key, the stored default automatic prefix is retrieved and a radiotelephone communication is initiated to the destination telephone using the retrieved default automatic prefix followed by the user-entered extension.”

### SUMMARY

An embodiment includes a method for identifying in a table of candidate records, each record having at least one field, comprising the steps of receiving an partial string; substring matching the partial string to at least one candidate record; and receiving a command to perform a function on at least one field of the candidate record.

Among the vast array of cool tricks available in one or more embodiments is that a user of an embodiment may input a brief substring into a communication device, and the communication device may initiate a communication based on a collection of more detailed strings.

### BRIEF DESCRIPTION OF THE DRAWINGS

The disclosed embodiments of the invention will be described with reference to the accompanying drawings, wherein:

FIG. 1 is a flowchart of steps according to an embodiment of the invention;

FIG. 2a is an example table that may be available;

FIG. 2b is a user interface of an embodiment;

FIG. 2c is an example of portions of strings that may be compared or modified by an embodiment; and

FIG. 3 is a block diagram of an embodiment.

### DETAILED DESCRIPTION

A transmit function may be any operation to transmit analog or digital traffic over conduits, e.g. wires, or by wireless, e.g. radio means. A transmit function may include sending digits to a telecommunications routing device such as a switch for processing, such as connecting to a valid phone number. The transmit function may include sending a call set-up signal from a mobile station, e.g. as used in various wireless telephony systems. A transmit function may include sending a text message to an address denoted by a telephone number, e.g. a numeric or alphanumeric page. A transmit function may include sending graphics to a remote device, including a fax machine.

A data operation may be any operation that stores, transmits or modifies data. Such data may be simple information such as a phone number and a name. Such information may include instructions or steps, such as instructions to dial an international access sequence, or instructions to pause between dialing digits.

Matching is any comparison of an expression string to a candidate string where a match is returned if the expression string is found in the candidate string. Similarly, a matching step may return the absence of a match if the expression string is not found in the candidate string. If an expression string matches at least once among all characters in a candidate string, then that is counted as a single match, even though the expression string may appear multiple times in the candidate string. If the expression string matches a string of the candidate string that begins with the first character of the candidate string, such a match does not occur deep in the candidate string.

Substring matching is any comparison of a expression string to a candidate string wherein a match is returned if the expression string is found in the candidate string following the first character of the candidate string. In other words, a match is signaled under substring matching, when the expression string is found deep in the candidate string. Similarly, substring matching may return the absence of a match if the expression string is not found in the candidate string anywhere following the first character. If a string matches at least onceamong all characters after a first character in a candidate string, then that is counted as a single match, even though the expression string may appear multiple times in the candidate string.

Extension matching is any comparison of an expression string of four or five digits wherein a match is returned if the expression string is found as the last substring of a candidate string, provided the candidate string is composed solely of digits.

Phone matching comprises two sorts of matching or relating of one string to another. Each sort of matching is a phone matching criterion. The first sort of matching is any comparison of an expression string of four or more digits wherein a match is returned if an expression string is found as the last substring of a candidate string, wherein the candidate string has telephonic instructions. The second sort of matching is any comparison of a expression string of three or fewer digits to a candidate string wherein a match is returned if the expression string is found in the candidate string at least one character deep into the candidate string.

A phone matched record may be a record having a candidate string that satisfies at least one phone matching criterion, e.g. a record having a candidate string satisfying a phone matching criterion is a phone match. A result of a phone match may include a candidate string satisfying a phone matching criteria.

Embedded phone matching is the same as phone matching, except that the embedded phone match of an expression string to a candidate is a match where the matched string does not cover the final character in the candidate string.

Substring expansion is a process of finding zero or more prefix strings of at least one character of an expression string. Substring expansion may optionally include finding a suffix string for the expression string wherein the prefix string occurs before a matching substring of the expression string in a record, and the suffix string occurs, if at all, after the match in a record. Substring expansion may include prepending the expression string with the prefix string and appending the suffix string, if any, to the result. Following the prepending operation and any appending operation, an expression string may become one or more augmented strings. An augmented string is necessarily longer than an expression string on which it is based.

Numeric completion or numeric completing is an operation where zero or more matches are detected among at least one candidate string wherein the expression string may match the first characters in a candidate string. A candidate string may include a telephone number with any telephonic instruction symbols. The operation of numeric completion may return at least one candidate string if a match occurs.

Under conditions where numeric completion fails to match an expression string to the first characters in the candidate string, numeric completion may provide a signal that matches do not occur.

A partial string is a string of at least one symbol or character that fails to meet the criteria for providing sufficient information to route a communication. Such a communication may be a telephone call including access to paging networks. Each country uses its own format to identify properly formed strings of digits. That format may distinguish between a partial string and a complete string of digits. A criterion may be that a string is too short and thus a partial string. For example, in the United States, complete numbers are generally any string of seven or more digits. By complete, I mean that that is the form in which telephone numbers are assigned regardless of whether the purported valid or complete string is actually assigned to a subscriber or device. A complete telephone number may be unassigned or disconnected. Private switches may permit fewer digits to be dialed, wherein the call does not reach the PSTN. In such a system, a completeness criterion or a validity criterion might be that all numbers having four or more digits comprise a complete string.

A subset of the universe of IETF-compliant Uniform Resource Locators or e-mail addresses may be addressed using telephone numbers, or strings in which telephone numbers are a part. As an example, a carrier in the United States, AT&T Wireless, uses an address of the form XXXYYYZZZZ@mobile.att.net wherein the string XXXYYYZZZZ is a variable string representing a telephone number that fits the validity criteria that telephone numbers are 10 digits long. Such an email address has two fields: a numeric field; and a domain-specific field. In this case, the domain specific field is ‘@mobile.att.net’.

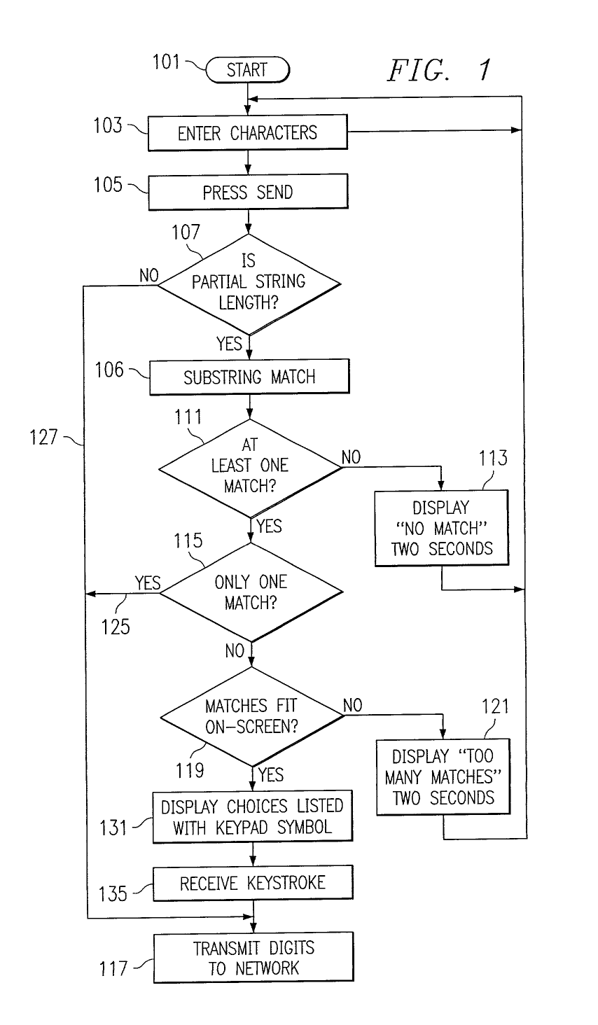

FIG. 1 shows a method according to an embodiment to locate a match according to substring matching between an expression string and candidate strings stored in a memory of a device, such as the short term memory of a mobile station. Substring matching may include numeric completion.

A mobile station may have a default steady state for receiving commands and data. For a mobile telephone, the default steady state generally occurs a few moments after powering up a phone that has service with a wireless carrier. The default steady state of the phone is the state where the mobile telephone will accept digits into memory such as a register in preparation to attempt a call through any available wireless carrier. Such a default steady state may give, via a display, vital operating conditions such as remaining battery life and availability of a compatible wireless carrier signal. Generally digits entered by a character-entry device, such as a keypad, are displayed to the display. Other states may exist in a mobile station. For example, modern mobile telephones may permit a user to add a telephone number with an accompanying string of alphabetic characters as a record in a telephone book. The state that the mobile telephone enters in order to accept such entries is called the phone-book entry state. Because the entry of phone-book entries is a helpful, but not essential, function of a mobile telephone, the phone-book entry state might not be the default steady state for the mobile telephone.

To begin the process according to an embodiment, a mobile station, or other communication device, may start in its default steady state 101. At least one character is entered 103 via a character-entry device, such as a keypad. Such a character may be any symbol of the character-entry device, including punctuation, however it is appreciated that entry of digits may be helpful. Several digits may be entered as the entry step 103 may be performed multiple times. At some point, a user enters a command 105. The command entry may be made by keystroke or some other user input. Such user input may be conscious or unconscious, i.e. it is possible that a button on a keypad is accidentally pushed. The command entry may be a command to transmit dialed digits to a wireless network, which may be indicated as a ‘send’ or ‘talk’ button on commonly available mobile telephones. The command entry may result in a data operation. A data operation may be the process of sending or transmitting digits. The data operation may result in an error or other non-optimal condition, particularly where network resources are not available, the important aspect is that the data operation is commanded to occur.

A test to determine adequacy or sufficiency of the entered characters to meet a minimal criterion to be complete for the type of command entry occurs 107, that is, a criterion step occurs. For example, for a data operation of sending digits to a publicly switched telephone network (PSTN) in the United States, a string of dialed digits must be at least seven digits long in order to be complete. Longer strings of digits may be complete under these circumstances. Any string of digits fewer than seven digits long, for purposes of using the PSTN thus is partial, and is determined to be a partial string length 107. Strings of digits that are determined to be complete may be sent to a PSTN or other telephony network, e.g. mobile telephone network, by transmitting call digits 117 by wire, wireless and other means.

Providing a partial string has been entered, at least one table is consulted to determine if there is a substring match 106 by the characters already entered. Such characters thus become an expression string. This may be done for each record in the table, if any. Each record may contain at least one candidate string. Once all records, if any, in the at least one table are exhausted, the number of matches determine the next step. If zero matches occur 111, a feedback may occur, which may include displaying “No Match” 113 to a display. If a determination that one match is made 115, then a data operation, e.g. transmitting call digits 117 occurs. Following the feedback, the character entry step 103 may resume. Any such characters entered at the character entry step 103 may be tacked on to the expression string, e.g. a processor may receive such inputs. Other editing operations may occur at the enter characters 103 step, including deleting characters, as is known in the art.

Alternatively, upon obtaining a determination that the partial numeric string is in a state of phone matching with one telephonic field 115, an embedded processor 303 (see FIG. 3) may simply store, or otherwise transmit the telephonic field. The execution of steps thus would take the positive branch 125 of the determining of one match step 115. An embedded processor or other devices may then later use the telephonic field by the commonly known practice of returning a result from a software function.

If determining step 115 shows that multiple matches occurred, a step to determine if the list of matches is presentable is made 119. A criterion for determining that matches are presentable 119 may be an inquiry as to whether a display has sufficient lines to display most of the details of each match. If the criterion is not met, a feedback may occur 121 such as “too many matches” being displayed to a display, if available. Such a feedback, or message, may appear for a few moments. After beginning to provide any feedback, operation may return to the step of entering characters 103. Any such characters entered at this point may be tacked on to the expression string.

If the matches are presentable, much of a first record may be displayed on a line of a display. Such a line may be prefaced by a setoff symbolic index to facilitate later selection by a user, e.g. “1”. Much of a second record may be displayed on a second line of a display. Again, an index, e.g. “2” may appear set-off from the record. Further records may be displayed. Each may have an index symbol alongside such display. Collectively providing such records is accomplished in the display choices step 131 wherein a processor may make a listing of results. A listing of results may have features in common with a menu.

Selection from amongst such records may use menu-selection controls as are known in the art, although, entry of an index symbol 135 may provide greater ease. In other words, a character entry device may provide an opportunity for a user to enter the index symbol 135.

By receiving at least one character that includes an index symbol, the communication device, e.g. a mobile station, may substring expand 106 the initially entered string that was collected through one or more iterations through ‘enter characters’ 103. The resultant string is an augmented string. A match result may comprise a resultant string.

Based on a keystroke that matches an index symbol, a data operation, e.g. transmitting call digits 117, may occur. Transmitting call digits maybe done with a wireless transceiver or a wired transceiver using protocols known to initiate a call at a telephony switch. The step of transmitting call digits may be a step of transmitting sufficient characters of a telephony field to be complete for purposes of establishing a call. Defects in wired or wireless network operation, congestion and other factors may prevent a call from actually occurring.

To confirm the number that the mobile station has matched, the mobile station may provide a distinctive feedback. The feedback may occur in several modes, which may include feedback of a sound emitted by, e.g. a speaker of a mobile station. Other modes may include the issuance of vibrations that may be felt, such as from a vibration motor. Such a motor may be actuated according to a pattern. A distinctive feedback may be assigned to a candidate record when a candidate record is either added to a table, or modified within a table. A distinctive feedback may sound like a ringtone, such as is known in the art to be used when a call is in the process of being received. A sound may be stored in a mobile station memory, using a microphone and digital compression techniques as are known in the art. Other methods for obtaining a sound, including downloading may also be used. A sound, if a ringtone, may be obtained or downloaded by methods used to obtain ringtones. A sound may be coupled by the user to operate when a call is received, when numeric completion has occurred or both. A distinctive feedback need not be unique. However a user of a mobile station may program or otherwise couple a distinctive feedback to one or more records.

This may accomplish for the user an effect, such that each time a single candidate record is identified by a method, e.g. as shown in FIG. 1, a confirmatory sensation occurs that may be sufficient for the user to verify that the one candidate record was not selected inadvertently, e.g. by a mistaken key-press. On the other hand a distinctive feedback may not comport with the intentions of a user. Under such a circumstance, the user may abandon the call attempt because of the mismatch evident between who the user intended to call, and the candidate record that the partial string uniquely matched among the candidate records. The issuance of a distinctive feedback may occur in instances where a user does not need to select among several matching candidates. Such an instance may occur, e.g. following the negative (n) exit from criterion step 127 or the positive (y) exit from determination of single match 125. In other words, the negative exit from criterion step 127 or positive (y) exit from determination of single match 125 may be single candidate record matches.

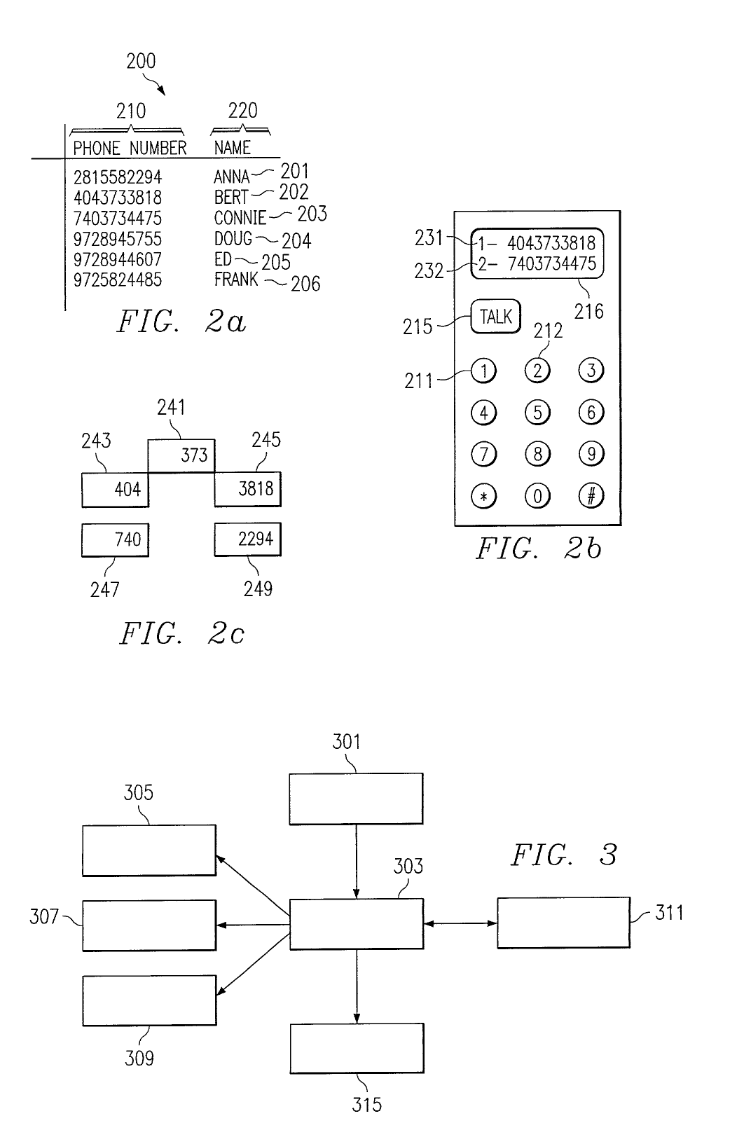

FIG. 2a shows an example table that may be available in a mobile telephone memory. This table may be created and edited by the user of the mobile telephone as a phone-book table. Each record may be comprised of two types of fields: a telephonic field 210 and a name field 220. The telephonic field 210 may contain digits 0, 1, 2, 3, 4, 5, 6, 7, 8 and 9 plus telephonic instructions represented by other symbols, such as ‘+’, ‘p’, and ‘w’. The numeric field need not contain only phone numbers. The name field 220 may permit storage of characters other than names, and may be empty.

In the example embodiment table, there are six records, 201, 202, 203, 204, 205 and 206. It is appreciated that equivalent tables may have more or less records, and more or less fields. Moreover, an equivalent table may be created ad hoc, i.e. by storing in a first in first out list calls made or attempted by a user. Such an ad hoc table may be a recently-dialed table. Other tables may be assembled on an ad hoc basis, based on calls received, calls missed, or other communications that are received or missed.

FIG. 2b shows a typical user interface to a mobile telephone. In this embodiment, the character-entry device is a keypad having a well-known 12-key keypad and at least one function button 215, in this case labeled ‘TALK’. Other function buttons may exist on the mobile telephone that permit a user to navigate a display 216 and any attendant functions revealed in the display. Such commands may command that a data operation occur with respect to data represented on the display 216.

FIG. 2c shows various strings that are related to the substring matching function. Several iterations or loops of the character entry step 103 may occur before a command is entered. For example three iterations through the character entry step may result from pressing the keypad keys marked ‘3’, ‘7’ and ‘3’. The loop may be exited upon entry of the ‘TALK’ key 215. Because the expression string 241 may be too short for any expected telephone number or other telephone address, execution of the criterion step 107 falls through to the detecting of matches 106 step. In this case two matches are found. The first comprises a prefix string 243 and a suffix string 245. The second comprises a prefix string 247 and a suffix string 249.

The display 216 may have sufficient lines to show the details of the first match 231 and any second match 232. The details may show much of the contents of a field of the table, e.g. one of the fields of the phone numbers 210. The details may show an augmented string, or at least significant portions of an augmented string. An index symbol may appear next to each choice, wherein the index symbol corresponds to a symbol selectable by the character-entry device. Thus the keys ‘1’ 211 and ‘2’ 212 may be active to receive a keystroke and complete the selection of the data operation 117, which in this case may be transmitting a set of digits to a telephony network.

Multiple tables may be searched contemporaneously in matching step 106 for an expression string. For example, there may be a table of recently called telephone numbers or a recently dialed table, which may be searched alone or with other tables. Such a table or tables may provide candidate strings for processing in the matching step 111. The choice of which table to search, if any, may be made by the user by way of configuration menus or the like, as is known in the art. Alternatively, the set of tables to search and thus attempt to match may be predetermined. A priority may be assigned to each table, even to each record of a table for purposes of determining an order that any substring matches are presented through, e.g. a display 216.

FIG. 3 shows a block diagram of a communication device that may carry out the functions and equivalents described herein, such as, e.g. those of FIG. 1. A character-entry device 301 receives inputs. One or more portions or keys of the character entry device may be a command entry device, e.g. a ‘talk’ or ‘send’ marked key. Such inputs may be associated with characters, symbols and functions. The character-entry device may depend on pressure, e.g. such as to a keypad to take character and other inputs. Character-entry device may provide characters and other inputs encoded by means known in the art to an embedded processor 303. Embedded processor 303 may provide outputs that are discernable to human beings in several forms, including visual displays, audio, and vibrations, which may be provided by output devices such as a display screen 305, a speaker 307 or a vibrate motor 309 respectively. Processor 303 may store and retrieve information from memory 311. Memory 311 may be preprogrammed with data and instructions. Memory 311 may be in a removable media. Communication device may be able to communicate with other devices through a transceiver 315. Transceiver 315 may be able to transmit and receive signals as electromagnetic signals or sound. At a minimum, transceiver 315 may be a transmitter. The transmitter may be a Dual Tone Multi-Frequency (DTMF) tone generator for providing tones on a pair of conductors. The transmitter may be a pulse generator providing pulses according to commonly known telephony switch protocols.

Although the invention has been described in the context of particular embodiments, various alternative embodiments are possible. As an example telephonic characters may include characters ‘*’ and ‘#’. Thus, while the invention has been particularly shown and described with respect to specific embodiments thereof, it will be understood by those skilled in the art that changes in form and configuration may be made therein without departing from the scope and spirit of the invention.

What is claimed is:

1. A method for identifying among at least one table of candidate records, each candidate record having at least one field, comprising:
receiving a partial string;
substring matching the partial string to at least one candidate record;
receiving a command to perform a function on at least one field of the at least one candidate record.

2. The method of claim 1 wherein the substring matching comprises a step of phone matching.

3. The method of claim 2 wherein the command comprises a command to send digits.

4. The method of claim 3 wherein the command comprises a choice among the at least one candidate record.

5. The method of claim 3 wherein the command to send digits comprises a command to send digits from a wireless transceiver.

6. The method of claim 2 wherein substring matching comprises matching the partial string deep in at least one field of the at least one candidate record.

7. The method of claim 6 wherein the at least one candidate record comprises a record of a favored table.

8. The method of claim 6 wherein the at least one candidate record comprises a telephonic field.

9. The method of claim 6 wherein the command comprises a choice among the at least two candidate records.

10. The method of claim 6 wherein the partial string comprises a string shorter than ten digits.

11 The method of claim 6 wherein the partial string comprises a string shorter than seven digits.

12. The method of claim 6 wherein the partial string comprises a portion of a phone number.

13. The method of claim 6 wherein the at least two candidate records each comprise a valid phone number.

14. The method of claim 13 wherein the command comprises a choice among the at least two candidate records.

15. The method of claim 8 wherein the at least one field of the at least one candidate record comprises a numeric field.

16. The method of claim 1 wherein substring matching comprises a step of listing at least two fields of at least two candidate records.

17. The method for identifying of claim 1, wherein the at least one candidate record is one candidate record, further comprising outputting a distinctive feedback.

18. The method for identifying of claim 17 wherein the outputting of a distinctive feedback comprises sounding a sound.

19. The method for identifying of claim 18 wherein the outputting of a distinctive feedback further comprises actuating a motor.

20. The method for identifying of claim 19 wherein the sound comprises a human voice.

21. The method for identifying of claim 17 wherein the outputting of a distinctive feedback comprises actuating a motor.

22. The method of claim 2 wherein the phone matching comprises a step of embedded phone matching.

23. The method of claim 22 wherein the command comprises a command to send digits.

24. The method of claim 22 wherein the at least one candidate record comprises a record of a favored table.

25. The method of claim 24 wherein the at least one candidate record comprises a record of a favored table.

26. The method of claim 25 wherein the at least one candidate record comprises a telephonic field.

27. The method for identifying of claim 26 wherein the outputting of a distinctive feedback comprises sounding a sound.

28. The method for identifying of claim 27 wherein the outputting of a distinctive feedback further comprises actuating a motor.

29. The method for identifying of claim 28 wherein the sound comprises a human voice.

30. The method for identifying of claim 29 wherein the outputting of a distinctive feedback comprises actuating a motor.

31. A communication device for identifying among at least one table of candidate records, each candidate record having at least one field, comprising:
a character-entry device for receiving a partial string;
a processor for substring matching the partial string to at least one candidate record;
a second character-entry device for receiving a command to perform a function on at least one field of the at least one candidate record.

32. The communication device of claim 31 wherein the processor for substring matching comprises a processor for phone matching.

33. The communication device of claim 32 wherein the second character-entry device for receiving a command comprises a character-entry device for entering a command to send digits.

34. The communication device of claim 33 wherein the command comprises a choice among the at least one candidate record.

35. The communication device of claim 34 wherein the command to send digits comprises a command to send digits from a wireless transceiver.

36. The communication device of claim 32 wherein the processor for substring matching comprises a processor for matching the partial string deep in at least one field of the at least one candidate record.

37. The communication device of claim 36 wherein the at least one candidate record comprises a record of a favored table.

38. The communication device of claim 36 wherein the at least one candidate record comprises a telephonic field.

39. The communication device of claim 36 wherein the command comprises a choice among the at least two candidate records.

40. The communication device of claim 36 wherein the partial string comprises a string shorter than ten digits.

41 The communication device of claim 36 wherein the partial string comprises a string shorter than seven digits.

42. The communication device of claim 36 wherein the partial string comprises a portion of a phone number.

43. The communication device of claim 36 wherein the at least two candidate records each comprise a valid phone number.

44. The communication device of claim 43 wherein the command comprises a choice among the at least two candidate records.

45. The communication device of claim 38 wherein the at least one field of the at least one candidate record comprises a numeric field.

46. The communication device of claim 31 wherein the processor for substring matching comprises a processor for listing at least two fields of at least two candidate records.

47. The communication device for identifying of claim 31, wherein the at least one candidate record is one candidate record, further comprising output device for outputting a distinctive feedback.

48. The communication device for identifying of claim 47 wherein the output device for outputting of a distinctive feedback comprises a speaker for sounding a sound.

49. The communication device for identifying of claim 48 wherein the output device for outputting of a distinctive feedback further comprises a vibrate motor.

50. The communication device for identifying of claim 49 wherein the sound comprises a human voice.

51. The communication device for identifying of claim 47 wherein the output device for outputting of a distinctive feedback comprises a vibrate motor.

52. The communication device of claim 32 wherein the processor for phone matching comprises a processor for embedded phone matching.

53. The communication device of claim 52 wherein the command comprises a command to send digits.

54. The communication device of claim 52 wherein the at least one candidate record comprises a record of a favored table.

55. The communication device of claim 54 wherein the at least one candidate record comprises a record of a favored table.

56. The communication device of claim 55 wherein the at least one candidate record comprises a telephonic field.

57. The communication device for identifying of claim 56 wherein the output device for outputting of a distinctive feedback comprises a speaker for sounding a sound.

58. The communication device for identifying of claim 57 wherein the output device for outputting of a distinctive feedback further comprises a vibrate motor.

59. The communication device for identifying of claim 58 wherein the sound comprises a human voice.

60. The communication device for identifying of claim 59 wherein the output device for outputting of a distinctive feedback comprises a vibrate motor.

71. A method for converting a numeric string to an augmented string comprising:
receiving an partial numeric string;
numeric completing the partial numeric string to obtain at least one augmented string;
performing a data operation on the at least one augmented string.

72. The method of claim 71 wherein numeric completing comprises:
comparing a telephonic field in at least one table to the partial numeric string, the telephonic field having first characters;
determining if first characters match the partial numeric string to obtain a determination that the partial numeric string matches the first characters; and
returning the telephonic field based on the determination that the partial numeric string matches the first characters.

73. The method of claim 72, wherein the at least one table comprises a table stored at a mobile station.

74. The method of claim 72 wherein the at least one table comprises a recently dialed table.

75. The method of claim 73 wherein the data operation comprises receiving a choice of the augmented string to obtain a chosen augmented string.

76. The method of claim 75 wherein the data operation comprises transmitting the chosen augmented string.

77. The method of claim 76 wherein the transmitting comprises transmitting the augmented string as a call set-up signal.

78. The method of claim 71 wherein numeric completing comprises:
comparing a telephonic field in a table to the partial numeric string;
determining if the partial number string phone matches the telephonic field to obtain a determination that the partial numeric string phone matches telephonic field; and
returning the telephonic field based on the determination that the partial numeric string phone matches the telephonic field.

79. The method of claim 78, wherein the telephonic field corresponds to a distinctive feedback, further comprising, outputting the distinctive feedback.

80. The method of claim 79, wherein the outputting of a distinctive feedback comprises sounding a sound.

81. The method claim 80, wherein the outputting of a distinctive feedback further comprises actuating a motor.

82. The method of claim 81, wherein the sound comprises a human voice.

83. The method of claim 82, wherein the outputting of a distinctive feedback comprises actuating a motor.
